(19) United States
(12) Patent Application Publication
(10) Pub. No.: US 2007/0089410 A1
(43) Pub. Date: Apr. 26, 2007

(54) Stirling engine

(75) Inventors: Kazushi Yoshimura, Kitakatsuragi-Gun (JP); Kenji Takai, Yamatotakada-Shi (JP); Yoshiyuki Kitamura, Yamatokoriyama-Shi (JP); Shinji Yamagami, Nabari-Shi (JP); Jin Sakamoto, Soraku-Gun (JP); Hiroshi Yasumura, Ikoma-Gun (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka (JP)

(21) Appl. No.: 10/561,273

(22) PCT Filed: Jun. 29, 2004
(86) PCT No.: PCT/JP04/09133

§ 371 Date: Dec. 19, 2005

(30) Foreign Application Priority Data
Jul. 8, 2003 (JP) 2003-193287
Oct. 22, 2003 (JP) 2003-361990

(51) Int. Cl. F02G 1/04; F01B 29/10

(52) U.S. Cl. 60/520

(57) ABSTRACT

In a Stirling engine, a hollow cylinder-like pressure vessel covers a cylinder, a piston, and a linear motor. The pressure vessel is divided into a ring-like portion and a dome-like portion at a position closer to the displacer installation side than a piston support-side end of the linear motor. At the divided portion, an outward-facing flange-shaped portion is formed for each of the ring-like portion and the dome-like portion. For temporary sealing of the pressure vessel, both flange-shaped portions are joined together and tightened by tightening rings and bolts. A performance check is performed in this state, and then outer peripheral portions of the flange-shaped portions are welded together for final sealing.

### TECHNICAL FIELD

The present invention relates to a Stirling engine, more particularly, to a free-piston Stirling engine.

### BACKGROUND ART

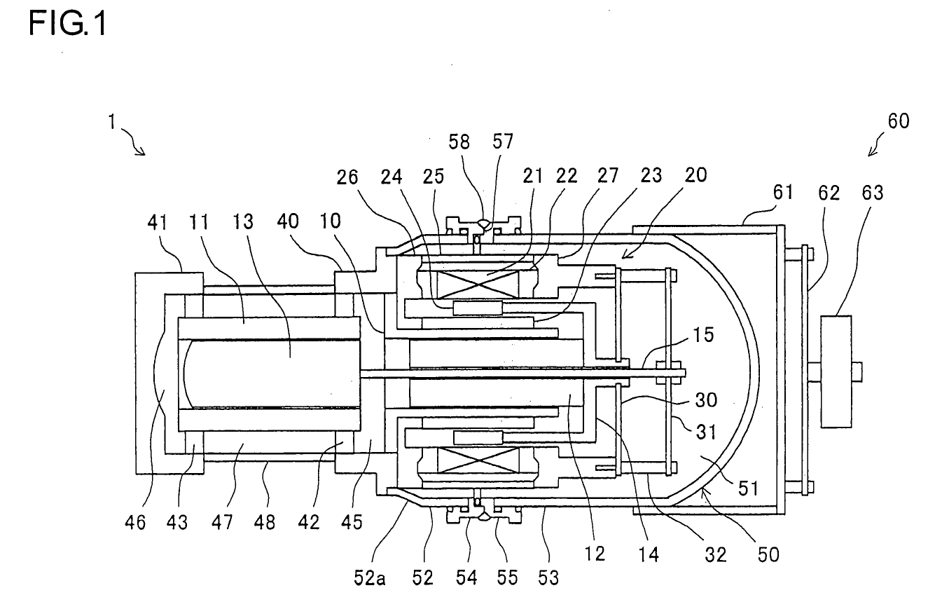

Stirling engines use, as a working gas, helium, hydrogen, or nitrogen instead of chlorofluorocarbons. It is for this reason that a Stirling engine has been receiving increasing attention as a heat engine that does not destroy the ozone layer. Examples of the Stirling engine are disclosed in Patent Publications 1 to 3.
Patent Publication 1: Japanese Patent Application Laid-Open No. 2000-337725 (pages 2 to 4, FIG. 1)
Patent Publication 2: Japanese Patent Application Laid-Open No. 2001-231239 (pages 2 to 4, FIG. 1)
Patent Publication 3: Japanese Patent Application Laid-Open No. 2002-349347 (pages 5 to 6, FIG. 1)

### DISCLOSURE OF THE INVENTION

Problems to be Solved by the Invention

The mass production of Stirling engines has not yet started. To achieve the mass production thereof, it is necessary at least to make them easy to assemble, and ensure stable quality of the assembled products.

The Stirling engine requires a delicate balance to keep operating, and therefore design and assembly adjustment have to be performed appropriately and elaborately to make the engine produce the intended performance. This makes it inevitable to conduct a performance test of each engine. The problem here is that, since components of the Stirling engine are sealed in a pressure vessel, it is difficult to perform re-adjustment when it has been found out that the engine does not produce the intended performance. In order to address this problem, it is necessary to review the structure of the pressure vessel that serves as an outer shell of the Stirling engine. The inventors of the present invention have found out that dividing the pressure vessel into two separate portions and dividing it at an appropriate division position greatly influence the ease of assembly and quality stability.

In view of the problem described above, an object of the present invention is to provide a Stirling engine that offers ease of assembly and ensures stable quality after assembly, and that makes easy adjustment after a performance test.

Means for Solving the Problem

To achieve the above object, according to one aspect of the present invention, a Stirling engine is provided with: a cylinder; a piston reciprocatably disposed inside the cylinder; a displacer that reciprocates with a phase difference relative to the piston; a linear motor that drives the piston; and a pressure vessel that encloses the cylinder, the piston, and the linear motor, and the pressure vessel has a division portion formed therein, and the division portion is located closer to where the displacer is disposed than to a piston support end of the linear motor. It is preferable that the division portion be located between the piston support end and the displacer side end of the linear motor, because the division portion located in this position makes it easy to connect a hermetic terminal (a terminal for feeding power to the linear motor) secured to the pressure vessel with a lead wire of the linear motor, and route the lead wire.

With this structure, when the pressure vessel is divided into two separate portions, the piston support side of the linear motor is exposed to the outside. In this state, it is possible to carry out wiring for the linear motor or assembly of the piston and the displacer. This makes assembly easy. Moreover, this eliminates the need to carry out troublesome assembly work, enhancing quality stability.

Preferably, according to another aspect of the present invention, in the Stirling engine structured as described above, the division portion is located in the central portion of the linear motor along the axis thereof.

With this structure, the division portion is located the same distance away from each of the synthetic resin end brackets located at the ends of the linear motor. This offers resistance to being damaged by heat produced by welding when the pressure vessel is sealed by welding the division portion. This too ensures stable quality.

Moreover, according to another aspect of the present invention, a Stirling engine is provided with: a cylinder; a piston reciprocatably disposed inside the cylinder; a displacer that reciprocates with a phase difference relative to the piston; a linear motor that drives the piston; and a pressure vessel that encloses the cylinder, and the pressure vessel has a division portion formed therein, and the division portion is formed into a shape that permits both temporary sealing for sealing with a seal member and final sealing for sealing with welding.

With this structure, it is possible to first conduct a performance test in a state where the pressure vessel is assembled by sealing it on a temporary basis. The pressure vessel is disassembled immediately as soon as any problem is identified, making it possible to eliminate a cause of the problem. This eliminates the need to discard a defective product, leading to elimination of waste of resources. Moreover, this makes it possible to ship all the products after making them meet the standard for quality, enhancing reliability of the product.

Preferably, according to another aspect of the present invention, in the Stirling engine structured as described above, the division portion is structured in such a way that a flange-shaped portion is formed on at least one pressure vessel body, a seal member placement clearance is formed in the flange-shaped portion, and a welding position is located around the outer circumference of the flange-shaped portion.

With this structure, by disposing a seal member in the flange-shaped portion, it is possible to perform temporary sealing with ease. Moreover, the welding position at the time of final sealing is located around the outer circumference of the flange-shaped portion, making it possible to prevent the components arranged inside the pressure vessel from being affected by heat produced by welding, for example, from being deformed thereby. It is to be noted that, when components made of resin are provided inside the pressure vessel such as when the end brackets of the linear motor are made of resin, such components are specially affected by heat. The present invention offers a structure suitable for such an article as provided with a component made of resin.

Preferably, according to another aspect of the present invention, in the Stirling engine structured as described above, the division portion is located closer to where the displacer is disposed than to a piston support end of the linear motor.

With this structure, when any problem is identified as a result of conducting a performance test in a state where the pressure vessel is assembled by sealing it on a temporary basis, it is possible to make the linear motor, the piston, and the support portion of the displacer exposed to the outside by disassembling the pressure vessel. This makes it easy to perform check/adjustment.

Preferably, according to another aspect of the present invention, in the Stirling engine structured as described above, the division portion is located in the central portion of the linear motor along the axis thereof.

With this structure, the division portion is located the same distance away from each of the synthetic resin end brackets located at the ends of the linear motor. Therefore, when the division portion is welded for final sealing, the end brackets on both sides are located the same distance away from the welding portion, making them less subject to damage by welding heat. This too ensures stable quality.

### ADVANTAGES OF THE INVENTION

According to the present invention, by dividing a pressure vessel into two separate portions, and dividing it at an appropriately positioned and shaped division portion, it is possible to offer benefits such as enhanced ease of assembly, enhanced quality stability, enhanced reliability, and enhanced ease of check/adjustment.

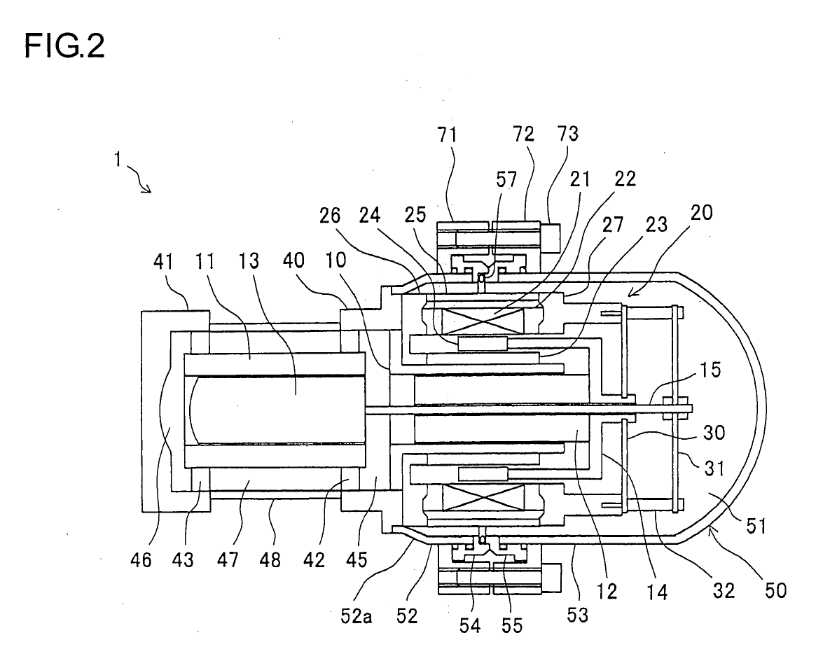

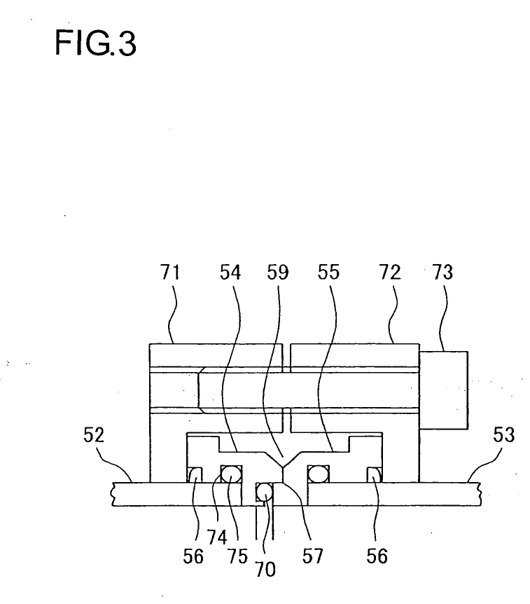

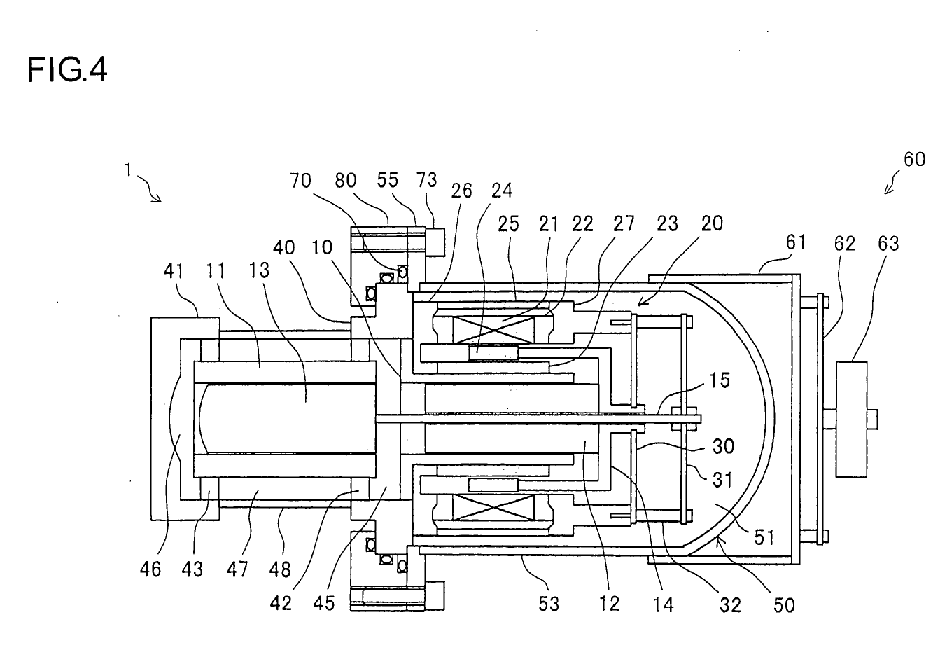

### BRIEF DESCRIPTION OF DRAWINGS

[FIG. 1] A side sectional view of the finished Stirling engine of a first embodiment.

[FIG. 2] A side sectional view of the Stirling engine of the first embodiment in a temporarily joined state.

[FIG. 3] A partially enlarged view of a principal portion of FIG. 2.

[FIG. 4] A side sectional view of the finished Stirling engine of a second embodiment.

### LIST OF REFERENCE SYMBOLS

1 Stirling engine

10, 11 cylinder

12 piston

13 displacer

20 linear motor

45 compression space

46 expansion space

50 pressure vessel

51 bounce space

52 ring-shaped portion

53 dome-shaped portion

54, 55 flange-shaped portion

57 seal member placement clearance

58 welding portion

71, 72 clamp ring

73 bolt

80 flange-shaped portion

### BEST MODE FOR CARRYING OUT THE INVENTION

Hereinafter, embodiments of the present invention will be described with reference to the accompanying drawings. FIGS. 1 to 3 show a first embodiment. FIG. 1 is a side sectional view of the finished Stirling engine, FIG. 2 is a side sectional view thereof in a temporarily joined state, and FIG. 3 is an enlarged view of a principal portion of FIG. 2.

A Stirling engine 1 is assembled around cylinders 10 and 11. The axis of the cylinder 10 aligns with that of the cylinder 11. The cylinder 10 has a piston 12 inserted therein, and the cylinder 11 has a displacer 13 inserted therein. When the Stirling engine 1 is operating, the piston 12 and the displacer 13 reciprocate without making contact with the inner walls of the cylinders 10 and 11 because of the presence of gas bearing.

The piston 12 has, at one end thereof, a cup-shaped magnet holder 14 fixed thereto. The displacer 13 has, at one end thereof, a displacer shaft 15 so formed as to protrude therefrom. The displacer shaft 15 penetrates the piston 12 and the magnet holder 14 in such a way that it can slidably move in the axial direction. When the Stirling engine 1 is operating, the displacer shaft 15 moves without making contact with the piston 12.

The cylinder 10 holds a linear motor 20 on the outside of the region where the piston 12 operates. The linear motor 20 is provided with an outer yoke 22 having a coil 21, an inner yoke 23 so formed as to be in contact with the outer surface of the cylinder 10, a ring-shaped magnet 24 that is inserted into an annular space between the outer yoke 22 and the inner yoke 23, synthetic resin end brackets 26 and 27 that hold the outer yoke 22 and the inner yoke 23 in a certain relative position, and a spacer 25 that keeps a certain distance between the end brackets 26 and 27. The magnet 24 is fixed to the magnet holder 14, and is supported thereby in such a way as not to make contact with any of the outer yoke 22 and the inner yoke 23.

The center of a spring 30 is fixed to the hub of the magnet holder 14, and the center of a spring 31 is fixed to the displacer shaft 15. The outer circumferential portions of the springs 30 and 31 are fixed to the end bracket 27. Between the outer circumferential portions of the springs 30 and 31, there is disposed a spacer 32, with which the springs 30 and 31 keep a certain distance between them. The springs 30 and 31 are made of disk-shaped material having spiral grooves, and resonate with the piston 12 and the displacer 13, respectively.

There are disposed heat-transfer heads 40 and 41 on the outside of the end portions (portions corresponding to the regions where the displacer 13 operates) of the cylinder 11. The heat-transfer head 40 in the shape of a ring and the heat-transfer head 41 in the shape of a cap are made of metal having high thermal conductivity such as copper or copper alloy. The heat-transfer head 40 is supported on the outer surface of the cylinder 11 with a ring-shaped internal heat exchanger 42 sandwiched therebetween, and the heat-transfer head 41 is supported thereon with a ring-shaped internal heat exchanger 43 sandwiched therebetween. The internal heat exchangers 42 and 43 are breathable, and conduct the heat of the working gas passing therethrough to the heat-transfer heads 40 and 41. The cylinder 10 and the pressure vessel 50 are connected to the heat-transfer head 40.

An annular space surrounded by the heat-transfer head 40, the cylinders 10 and 11, the piston 12, and the internal heat exchanger 42 serves as a compression space 45, and an annular space surrounded by the heat-transfer head 41, the cylinder 11, the displacer 13, and the internal heat exchanger 43 serves as an expansion space 46.

There is disposed a regenerator 47 between the internal heat exchangers 42 and 43. The regenerator 47 too is breathable, and allows the working gas to pass therethrough. The outside of the regenerator 47 is covered with a regenerator tube 48. The regenerator tube 48 establishes an airtight path between the heat-transfer heads 40 and 41.

A tubular pressure vessel 50 encloses the linear motor 20, the cylinder 10, and the piston 12. The space inside the pressure vessel 50 serves as a bounce space 51. The structure of the pressure vessel 50 will be described in detail below.

The pressure vessel 50 has a vibration dampener 60 attached thereto. The vibration dampener 60 is composed of a frame 61 fixed to the pressure vessel 50, a plate spring 62 supported by the frame 61, and a mass 63 supported by the spring 62.

The Stirling engine 1 operates as follows. When the coil 21 of the linear motor 20 is fed with an alternating current, it produces a magnetic field that passes through the magnet 24 between the outer yoke 22 and the inner yoke 23, making the magnet 24 reciprocate in the axial direction. By feeding electric power having a frequency corresponding to a resonate frequency that is determined based on the total mass of a piston system (the piston 12, the magnet holder 14, the magnet 24, and the spring 30) and a spring constant of the spring 30, the piston system starts to sinusoidaly reciprocate smoothly.

On the other hand, a resonate frequency that is determined based on the total mass of a displacer system (the displacer 13, the displacer shaft 15, and the spring 31) and a spring constant of the spring 31 is set so as to resonate with a drive frequency of the piston 12.

When the piston 12 is made to reciprocate, the compression space is repeatedly compressed and expanded. With this change in pressure, the displacer 13 is made to reciprocate. At this time, the flow resistance between the compression space 45 and the expansion space 46, for example, produces a phase difference between the displacer 13 and the piston 12. In this way, the free-piston displacer 13 oscillates with a phase difference relative to the piston 12 in synchronism with the oscillation frequency thereof.

As a result of the operation described above, a Stirling cycle is formed between the compression space 45 and the expansion space 46. In the compression space, the temperature of the working gas is increased by isothermal compression; in the expansion space 46, the temperature of the working gas is reduced by isothermal expansion. As a result, the temperature in the compression space 45 is increased, and the temperature in the expansion space 46 is reduced.

When passing through the internal heat exchangers 42 and 43, the working gas that travels back and forth between the compression space 45 and the expansion space 46 during the operation conducts its heat smoothly to the heat-transfer heads 40 and 41 via the internal heat exchangers 42 and 43. The temperature of the working gas flowing from the compression space 45 into the regenerator 47 is so high that the heat-transfer head 40 is heated to become a warm head. The temperature of the working gas flowing from the expansion space 46 into the regenerator 47 is so low that the heat-transfer head 41 is cooled down to become a cold head. The heat is diffused from the heat-transfer head 40 into the atmosphere, and the temperature in a specific space is cooled down by the heat-transfer head 41. In this way, the Stirling engine 1 functions as a refrigerating engine.

The regenerator 47 allows the passage of only the working gas, and does not conduct the heat from the compression space 45 to the expansion space 46, and vice versa. When passing through the regenerator 47, the high-temperature working gas that flows from the compression space 45 into the regenerator 47 via the internal heat exchanger 42 provides heat to the regenerator 47, whereby its temperature falls, and then flows into the expansion space 46. When passing through the regenerator 47, the low-temperature working gas that flows from the expansion space 46 into the regenerator 47 via the internal heat exchanger 43 recovers heat from the regenerator 47, whereby its temperature rises, and then flows into the compression space 45. That is, the regenerator 47 serves as a thermal storage device.

The pressure vessel 50 is structured as follows. The pressure vessel 50 is divided into two separate portions: one of which is a ring-shaped portion 52 that is one pressure vessel body connected to the heat-transfer head 40; and the other of which is a dome-shaped portion 53 that is the other pressure vessel body connected to the ring-shaped portion 52. A division plane is perpendicular to the axis of the Stirling engine 1, and is so located as to cross the linear motor 20. The position at which the division plane crosses the linear motor 20 is located closer to where the displacer is disposed than to the piston support end of the linear motor 20; in this embodiment, specifically, it crosses the linear motor 20 in the central portion thereof along the axis thereof.

The ring-shaped portion 52 and the dome-shaped portion 53 are made of stainless steel. The ring-shaped portion 52 is tapered at one end, and the tapered end is brazed to the heat-transfer head 40. The tapered portion 52a helps reduce the volume of the bounce space 51. At the other end of the ring-shaped portion 52 and an opposed open end of the dome-shaped portion 53, there are disposed flange-shaped portions 54 and 55.

The structure of the flange-shaped portions 54 and 55 will be described in detail with reference to FIG. 3. The flange-shaped portions 54 and 55 are formed as separately-molded stainless steel rings and welded to the ring-shaped portion 52 and the dome-shaped portion 53, respectively, by fillet weld 56. At the inner circumference of the flange-shaped portions 54 and 55, a seal member placement clearance 57 is so formed as to be concave on the flange-shaped portion 54 side and convex on the flange-shaped portion 55 side. When sealing is performed on a temporary basis, it is possible to maintain airtightness by disposing a ring-shaped seal member 70 in the seal member placement clearance 57.

The surfaces of the flange-shaped portions 54 and 55 opposite to the surfaces thereof where they are joined together are the contact surfaces at which they make contact with clamp rings 71 and 72 when temporary sealing is performed, and are each formed so as to have a concave for preventing a brazing material from flowing from the contact surface when fillet weld 56 is applied.

The flange-shaped portions 54 and 55 have, in the inner circumferential surfaces thereof, ring-shaped groves 74. Inside each ring-shaped groove 74, there is disposed a ring-shaped seal member 75 for maintaining airtightness between the flange-shaped portion 54 and the ring-shaped portion 52, and between the flange-shaped portion 55 and the dome-shaped portion 53.

The end surfaces of the flange-shaped portions 54 and 55 will be finally welded together at the edges so that they are joined together by a welding portion 58 (see FIG. 1) on a permanent basis. To permit welding, a groove portion 59 (see FIG. 3) is formed around the seam between the flange-shaped portions 54 and 55, so as to make it easy to place a brazing material therein. In the present invention, the flange-shaped portions 54 and 55 are joined together on a temporary basis before they are joined together by welding on a permanent basis, and, in this state, a performance test of the Stirling engine is conducted.

Temporary sealing is performed as follows. First, as shown in FIG. 3, the seal member 70 is placed in the seal member placement clearance 57 on the flange-shaped portion 54 side. The seal member 70 is an O ring. Then, when the end surface of the flange-shaped portion 55 makes contact with the end surface of the flange-shaped portion 54, the seal member 70 is sandwiched between the flange-shaped portions 54 and 55.

Then, as shown in FIG. 2, the flange-shaped portions 54 and 55 are sandwiched between a pair of clamp rings 71 and 72. When these clamp rings 71 and 72 are fixed together with a bolt 73, the seal member 70 is compressed and deformed, ensuring good airtightness between the flange-shaped portions 54 and 55. This prevents the working gas from leaking out of the pressure vessel 50 even when the internal pressure thereof is increased.

A performance test is conducted to check the Stirling engine I in a temporarily sealed state. If any problem is identified, the clamp rings 71 and 72 are unfixed by loosening the bolt 73, and the dome-shaped portion 53 is detached from the ring-shaped portion 52 so as to permit check and adjustment of the individual parts. When the dome-shaped portion 53 is detached, the linear motor 20 is exposed to the outside, because the division portion is so located as to cross the linear motor 20. This makes easy check/adjustment of the linear motor 20.

After a cause of the problem is eliminated by check/adjustment, the dome-shaped portion 53 is restored to its initial position and joined on a temporary basis. Then, a second performance test is conducted.

When the intended performance is achieved in a temporarily sealed state, final sealing is then performed. Final sealing is performed by detaching the clamp rings 71 and 72 and welding the tapered portion 59. Prior to welding, the seal member 70 is removed. Note that the seal member 70 may be left between the flange-shaped portions 54 and 55 if it is made to withstand heat produced by welding. The seal member 75 is required to be capable of withstanding heat produced by welding, because it is not detachable.

In final sealing, the flange-shaped portions 54 and 55 are welded together at the outer circumferential portions thereof, which are located farther from the components inside the pressure vessel 50. This reduces the possibility that the components inside the pressure vessel 50 are damaged by heat produced by welding.

In this embodiment, the division portion of the pressure vessel 50 is located in the central potion of the linear motor 20 along the axis thereof. This makes it possible to make the end brackets 26 and 27 located the same distance away from the welding position, making it difficult for heat produced by welding to reach the end brackets 26 and 27. Therefore, even if the synthetic resin end brackets 26 and 27 are used, they are less subject to damage from heat. Moreover, this embodiment is so built that the springs 30 and 31 are fixed to the end bracket 27. Thus, when the end bracket 27 is deformed, there is a possibility that the springs 30 and 31 are dislocated from the initially set positions. Such dislocation affects the volumes of the compression space 45 and the expansion space 46 and the vibration systems of the piston and the displacer. With the structure as described above, however, such dislocation never occurs even when heat is produced by welding. This makes it possible to yield higher performance.

In this embodiment, the division portion is formed into a shape that permits both temporary sealing and final sealing; in practice, it is possible to adopt a shape that permits only final sealing. Although, in this case, it is impossible to perform check and adjustment by removing temporary sealing, it is possible to obtain the same benefit as that obtained with the structure described above; specifically, it is possible to facilitate wiring in the assembly process such as connecting of a hermetic terminal (a terminal for feeding power to the linear motor) secured to the pressure vessel with a lead wire of the linear motor, and routing of the lead wire, and, in addition, offer resistance to being affected by heat produced by welding.

A second embodiment is shown in FIG. 4. FIG. 4 is a side sectional view of the finished Stirling engine. It is to be noted that such components as find their identical or functionally equivalent counterparts in the first embodiment are identified with the same reference numerals, and description thereof will be omitted.

A pressure vessel 50 is composed of a dome-shaped portion 53 having, at the open end thereof, a ring welded thereto to form a flange-shaped portion 55, and a heat-transfer head 40. The division plane of the pressure vessel 50 is located on that side of the linear motor 20 where the displacer 13 is disposed.

Temporary sealing is performed in such a way that the flange-shaped portion 55 of the pressure vessel 50 and a flange-shaped portion 80 engaged with the heat-transfer head 40 are fixed together with a bolt 73. Seal members 70 are sandwiched between the flange-shaped portion 55 and the flange-shaped portion 80, between the outer circumferential surface of the heat-transfer head 40 and the inner circumferential surface of the flange-shaped portion 80, and between the outer side surface of the heat-transfer head 40 and the inner side surface of the flange-shaped portion 80, ensuring good airtightness between them.

In the second embodiment, the bolt 73 is fastened with a specified tightening torque for “temporary sealing”, and then a performance test of the Stirling engine 1 is conducted. If any problem is identified, the flange-shaped portions 55 and 80 are decoupled by loosening the bolt 73, the dome-shaped portion 53 is detached from the heat-transfer head 40, and then the individual parts are adjusted. On completion of adjustment, the dome-shaped portion 53 is restored to its initial position and joined on a temporary basis, and then a performance test is conducted. When the intended performance is achieved, the bolt 73 and the flange-shaped portion 80 are removed, and then the heat-transfer head 40 and the flange-shaped portion 55 are welded together. In this way, final sealing is performed.

Obviously, many modifications and variations of the present invention are possible in light of the above teachings. It is therefore to be understood that within the scope of the appended claims, the invention may be practiced other than as specifically described.

### INDUSTRIAL APPLICABILITY

The present invention finds wide application in the production of a Stirling engine.

1-6. (canceled)

7. A Stirling engine comprising:
a cylinder;
a piston reciprocatably disposed inside the cylinder;
a displacer that reciprocates with a phase difference relative to the piston;
a linear motor that drives the piston; and
a pressure vessel that encloses the cylinder, the piston, and the linear motor,
wherein the linear motor has, at both ends thereof, synthetic resin end brackets, and wherein the pressure vessel has a division portion formed therein, the division portion being located in a central portion of the linear motor along an axis thereof.

8. A Stirling engine comprising:
a cylinder;
a piston reciprocatably disposed inside the cylinder;
a displacer that reciprocates with a phase difference relative to the piston;
a linear motor that drives the piston; and
a pressure vessel that encloses the cylinder, the piston, and the linear motor,
wherein the pressure vessel has a division portion formed therein, the division portion being formed into a shape that permits both temporary sealing for sealing with a seal member and final sealing for sealing with welding.

9. The Stirling engine of claim 8,
wherein, in the division portion,
a flange-shaped portion is formed on at least one pressure vessel body,
a seal member placement clearance is formed in the flange-shaped portion, and
a welding position is located around an outer circumference of the flange-shaped portion for final sealing.

10. The Stirling engine of claim 8,
wherein the division portion is located closer to where the displacer is disposed than to a piston support end of the linear motor.

11. The Stirling engine of claim 9,
wherein the division portion is located closer to where the displacer is disposed than to a piston support end of the linear motor.
